(19) United States
(12) Patent Application Publication
(10) Pub. No.: US 2026/0320894 A1
(43) Pub. Date: Oct. 15, 2026

(54) VIRTUAL CHARACTER INTERACTION METHOD AND DEVICE, MEDIUM, AND PROGRAM PRODUCT

(71) Applicant: Beijing Zitiao Network Technology Co., Ltd., Beijing (CN)

(72) Inventors: Zichao WEI, Beijing (CN); Jiamin HUANG, Beijing (CN); Tingshuo CHEN, Beijing (CN)

(21) Appl. No.: 19/646,839

(22) Filed: Apr. 14, 2026

(30) Foreign Application Priority Data
Apr. 14, 2025 (CN) 202510468002.1

(51) Int. Cl. G06T 13/40; G06T 13/20; G06T 19/20; G06V 10/82

(52) U.S. Cl. CPC G06T 13/40; G06T 13/205; G06T 19/20; G06V 10/82; G06T 2219/2004; G06T 2219/2024

(57) ABSTRACT

Embodiments of the present disclosure provide a virtual character interaction method and a device, a medium, and a program product. The method includes: acquiring a speech text and configuration information, where the speech text includes request information to be interacted with a virtual character, and the configuration information includes a style category of the virtual character; determining a response text according to the speech text, determining an audio sequence and a phoneme sequence according to the response text, and determining a speech symbol corresponding to a phoneme in the phoneme sequence; and determining a lip movement driving parameter according to the speech symbol and the style category, generating a video frame sequence according to the lip movement driving parameter and the virtual character, and outputting a virtual character interaction video composed of the video frame sequence and the audio sequence.

### CROSS-REFERENCE TO RELATED APPLICATION(S)

This application claims priority to Chinese Application No. 202510468002.1 filed Apr. 14, 2025, the disclosure of which is incorporated herein by reference in its entirety.

### TECHNICAL FIELD

Embodiments of the present disclosure relate to computer technologies and, in particular, to a virtual character interaction method and a device, a medium, and a program product.

### BACKGROUND

With the development of computer technologies, as a new type of interaction, virtual humans have been used in various fields. A virtual human may provide services such as information inquiry or business handling, which may greatly improve service efficiency and user experience.

### SUMMARY

The present disclosure provides a virtual character interaction method and a device, a medium, and a program product.

In a first aspect, an embodiment of the present disclosure provides a virtual character interaction method, including:
acquiring a speech text and configuration information, where the speech text includes request information to be interacted with a virtual character, and the configuration information includes a style category of the virtual character;
determining a response text according to the speech text, determining an audio sequence and a phoneme sequence according to the response text, and determining a speech symbol corresponding to a phoneme in the phoneme sequence, where the speech symbol is used to describe lip movement information corresponding to the phoneme; and
determining a lip movement driving parameter according to the speech symbol and the style category, generating a video frame sequence according to the lip movement driving parameter and the virtual character, and outputting a virtual character interaction video composed of the video frame sequence and the audio sequence.

In a second aspect, an embodiment of the present disclosure further provides an electronic device, including:
one or more processors; and
a storage apparatus, configured to store one or more programs,
when the one or more programs are executed by the one or more processors, the one or more processors are caused to implement the virtual character interaction method according to any embodiment of the present disclosure.

In a third aspect, an embodiment of the present disclosure further provides a storage medium including computer-executable instructions, where the computer-executable instructions are used to perform the virtual character interaction method according to any embodiment of the present disclosure when being executed by a computer processor.

In a fourth aspect, an embodiment of the present disclosure further provides a computer program product, including a computer program, where the virtual character interaction method according to any embodiment of the present disclosure is implemented when the computer program is executed by a processor.

An embodiment of the present disclosure provides a virtual character interaction method, including: acquiring a speech text and configuration information, where the configuration information includes a style category of a virtual character; determining a response text according to the speech text, determining an audio sequence and a phoneme sequence according to the response text, and determining a speech symbol corresponding to a phoneme in the phoneme sequence; and determining a lip movement driving parameter according to the speech symbol and the style category, generating a video frame sequence according to the lip movement driving parameter and the virtual character, and outputting a virtual character interaction video composed of the video frame sequence and the audio sequence. Since the speech symbol is determined according to the phoneme sequence, and the lip movement driving parameter is determined according to the speech symbol and the style category, the virtual character is driven by the lip movement driving parameter to make a lip movement corresponding to the audio sequence.

### BRIEF DESCRIPTION OF THE DRAWINGS

The above and other features, advantages, and aspects of the embodiments of the present disclosure will become more apparent in combination with the drawings and with reference to the following specific implementations. Throughout the drawings, the same or similar reference numbers refer to the same or similar elements. It should be understood that the drawings are schematic, and the components and elements are not necessarily drawn to scale.

FIG. 1 is a schematic flowchart of a virtual character interaction method according to an embodiment of the present disclosure;

FIG. 2 shows a public cloud deployment solution of a virtual character interaction system according to an embodiment of the present disclosure;

FIG. 3 shows a private cloud deployment solution of a virtual character interaction system according to an embodiment of the present disclosure;

FIG. 4 is a schematic flowchart of another virtual character interaction method according to an embodiment of the present disclosure;

FIG. 5 is a flowchart of a method for generating a virtual character interaction video in a virtual character interaction method according to an embodiment of the present disclosure;

FIG. 6 is a schematic structural diagram of a virtual character interaction apparatus according to an embodiment of the present disclosure; and

FIG. 7 is a schematic structural diagram of an electronic device according to an embodiment of the present disclosure.

### DETAILED DESCRIPTION OF EMBODIMENTS

Hereinafter, embodiments of the present disclosure will be described in more detail with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that the various steps described in the method implementations of the present disclosure may be performed in different orders and/or in parallel. In addition, the method implementations may include additional steps and/or omit the steps shown. The scope of the present disclosure is not limited in this regard.

As used herein, the term "include/comprise" and its variants are open-ended inclusions, that is, "include/comprise but not limited to". The term "based on" is "at least partially based on". The term "an embodiment" means "at least one embodiment"; the term "another embodiment" means "at least one other embodiment"; the term "some embodiments" means "at least some embodiments". Relevant definitions of other terms will be given in the following description.

It should be noted that concepts such as "first" and "second" mentioned in the present disclosure are only used to distinguish different apparatuses, modules, or units, and are not used to limit the order of functions performed by these apparatuses, modules, or units or interdependence therebetween.

It should be noted that the modifiers "one" and "multiple" mentioned in the present disclosure are illustrative and not restrictive, and those skilled in the art should understand that unless otherwise clearly indicated in the context, they should be understood as "one or more".

The names of messages or information exchanged between multiple apparatuses in the implementations of the present disclosure are only for illustrative purposes, and are not intended to limit the scope of these messages or information.

It may be understood that the data involved in the technical solution (including but not limited to the data itself, acquisition or use of the data) should comply with requirements of corresponding laws, regulations, and related provisions.

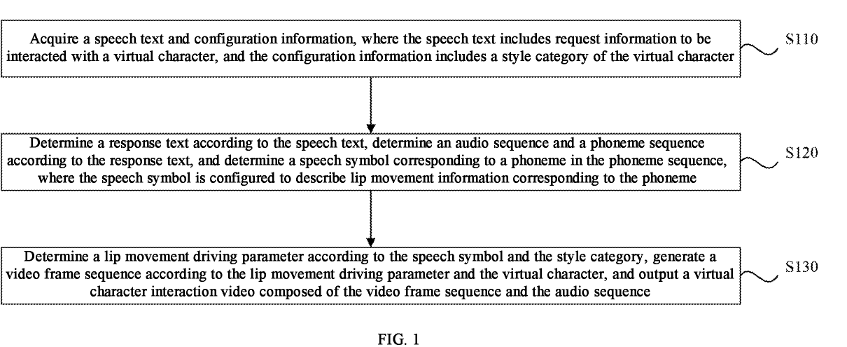

In related technologies, the lip movement of a virtual human talking often lags behind the voice, does not match the voice, or is too rigid, which affects the authenticity and immersion of the user experience. FIG. 1 is a schematic flowchart of a virtual character interaction method according to an embodiment of the present disclosure. The embodiment of the present disclosure is applicable to a library scenario. The method may be performed by a virtual character interaction apparatus, which may be implemented in the form of software and/or hardware. Optionally, the method is implemented by an electronic device, which may be a mobile terminal, a PC, a server, or the like.

As shown in FIG. 1, the method includes:

S110, a speech text and configuration information are acquired, where the speech text includes request information to be interacted with a virtual character, and the configuration information includes a style category of the virtual character.

A virtual character refers to a virtual object created and used by computer means and having interaction capability. For example, the virtual character may include at least one of a virtual human, a virtual animal, a virtual anthropomorphic object, and the like. The style category of the virtual character is used to represent an image style of the virtual character. For example, the virtual character may include a photorealistic style, an anime style, or the like. The appearance features and interaction capability of the virtual character in the photorealistic style are similar to those of a real human. The interaction capability of the virtual character in the anime style is similar to that of a real human, but the appearance features are different from those of a real human. For example, the virtual character in the anime style includes a virtual character with a cartoon character image and/or a virtual character with a cartoon animal image.

The request information includes a book inquiry request and/or a business handling request in a library, etc. The configuration information may be information corresponding to a user operation on the user terminal device or the intelligent interaction device in the library. For example, the user operation may include a touch operation and/or a voice wake-up operation. The image selection and version selection of the virtual character, and the operation that the virtual character needs to perform are implemented through the user operation.

Exemplarily, a server acquires the speech text and the configuration information sent by a user terminal device. For example, the user terminal device may be at least one of a mobile terminal, a PC, and a vehicle-mounted terminal. The user terminal device logs in to a book management system through a website of the library. The book management system includes a virtual character interaction module and the like. For example, the virtual character interaction module includes a preset knowledge base, virtual character data, and the like. Speech data is collected by the user terminal device. For example, the speech data may be collected by a microphone of the user terminal device. A user speech pause is detected by a preset detection algorithm. An interface of a speech-to-text service is built in the user terminal device, and the speech-to-text service is called through the interface to convert the speech data into the speech text. The configuration information is acquired through a button, a touch screen, or a microphone of the user terminal device. The book management system is used to manage account data and/or book information, etc. The book management system is used to manage at least one of account creation time, account cache data, account login method, and book inquiry data. The virtual character interaction module is used to access the account data or the book information.

Optionally, in order to support degree of concurrency of online calls, the server adopts a cluster deployment mode. More users may access the book management system using the user terminal device in a public network environment and interact with the virtual character in real time. In some embodiments, a remote interaction function of the virtual character in the public network environment is provided, so that the user may quickly and conveniently access the book management system through a browser and conduct a face-to-face voice conversation with the virtual character.

Optionally, the speech text and the configuration information sent by the intelligent interaction device in the library are acquired. For example, the user is in the library and inputs the configuration information by pressing a button or a touch screen on the intelligent interaction device in the library. Alternatively, the user may also input configuration speech through the microphone of the intelligent interaction device in the library. Thus, the virtual character to be interacted with is selected and the virtual character is awakened to start a conversation. Speech data is collected by the microphone of the intelligent interaction device in the library. A user speech pause is detected by a preset detection algorithm. An interface of a speech-to-text service is built in the intelligent interaction device in the library, and the speech text service is called through the interface to convert the speech data into the speech text.

Optionally, since the intelligent interaction device in the library has a requirement for data encryption and is limited by an intranet environment, the server in the embodiment of the present disclosure may adopt a private cloud deployment mode, so that all user data and communication data are limited to an internal network of the library. The private cloud deployment ensures security of public resources of the library. The public resources of the library managed through the private cloud include in-library collection information and/or user information, which ensures user information security and in-library network security.

Through the solution of combining public cloud deployment and private cloud deployment, the user may access the library system through the user terminal device or may access the library system through the intelligent interaction device in the library, which implements multi-terminal cross-platform access to the book management system.

Optionally, the user terminal device or the intelligent interaction device in the library communicates with the server through real-time audio and video transmission technology.

Optionally, in response to a broadcast event, a preset script is executed to determine broadcast content and the configuration information, and the speech text is determined according to the broadcast content. For example, for events such as new book release and venue scene update, a broadcast notification operation is triggered by the broadcast event. A preset script is executed in response to a play event being triggered. The preset script is used to configure at least one of information such as a broadcast content range, a broadcast duration, a style category of the virtual character, and a version of the virtual character. The preset knowledge base is searched according to the broadcast content range to obtain the broadcast content. The speech text is determined according to the broadcast content. For a new book broadcast event, the broadcast content range may be new books introduced into the library in recent n days, etc. For an activity broadcast event, the broadcast content range may be activities to be held in recent n days, etc.

S120, a response text is determined according to the speech text, an audio sequence and a phoneme sequence are determined according to the response text, and a speech symbol corresponding to a phoneme in the phoneme sequence is determined, where the speech symbol is used to describe lip movement information corresponding to the phoneme.

The response text includes response information to the request information in the speech text. For example, provided that the request information is to find a book about artificial intelligence, the response information may include at least one of a name, a cover, a table of contents page, an introduction, or the like of a book on artificial intelligence. The response text is determined according to the response information. Optionally, a picture of the cover or a target page may be inserted into the response text in the form of a uniform resource locator. Alternatively, an introduction video about the book may also be inserted into the response text in the form of a uniform resource locator.

Optionally, a frequency of historically asked questions in the library is determined, and a target question and a corresponding answer are selected according to the frequency. The answer includes a Speech Synthesis Markup Language (SSML) tag. According to an actual scenario, at least one of pronunciation, pause, global speaking speed, local speaking speed, global tone, local tone, global volume, local volume, and text emotion of the response text corresponding to the answer may be customized based on the SSML. A question-answer pair is composed of the target text and the answer added with the SSML tag, and the preset knowledge base is composed of the question-answer pair, other resource information in the library, and the like.

The audio sequence represents audio arranged according to a timestamp corresponding to the response text. The phoneme sequence may represent phonemes arranged according to a timestamp corresponding to the response text. The response text may be converted into audio data by a Text-to-Speech (TTS) model. For example, the audio data may include a Mel spectrogram or an audio waveform, etc. The audio sequence of the virtual character in the interaction process is determined by the audio data. The SSML tag in the response text may also be extracted by the TTS model. In addition, the phoneme sequence corresponding to the response text may also be determined by the TTS model. A phoneme is a minimum speech unit and a minimum element that constitutes a syllable.

The speech symbol is used to describe the lip movement information corresponding to the phoneme, for example, initials in Chinese pinyin include a retroflex consonant, a front high vowel, a back low vowel, and the like. Finals include a velar nasal and a nasalized vowel, etc. English letters include a plosive and an interdental fricative, etc. Optionally, the speech symbol may include an International Phonetic Alphabet (IPA) symbol.

Exemplarily, a book management system is retrieved according to the speech text to obtain the response text corresponding to the speech text, where the response text includes a speech synthesis markup language tag. The audio sequence and the phoneme sequence are generated according to the response text. Audio configuration information is determined according to the speech synthesis markup language tag, and an audio attribute of the audio sequence is updated according to the audio configuration information.

Optionally, retrieving a book management system according to the speech text to obtain the response text corresponding to the speech text includes: sending the speech text to the book management system, and retrieving, by the book management system, a question in a preset knowledge base based on the speech text; and determining the response text according to an answer corresponding to the question matching the speech text, where the answer includes the speech synthesis markup language tag. By retrieving a question-answer pair in the preset knowledge base, time consumption for answer searching may be reduced and interaction efficiency may be improved. It is possible to extract a keyword in the speech text and then determine the question matching the speech text by means of keyword matching. Alternatively, the keyword in the speech text may be vectorized to obtain a keyword vector. Then, a text vector is determined according to the keyword vector. Cosine similarity between the text vector and a vector representation of the question is calculated, and the question matching the speech text is determined according to the cosine similarity. Determining the text vector according to the keyword vector may include: averaging the keyword vector to obtain the text vector. Alternatively, a weighted operation is performed on the keyword vector to obtain the text vector. A weight corresponding to each keyword vector may be a preset value.

Optionally, sending the speech text to the book management system, and retrieving, by the book management system, the question in the preset knowledge base based on the speech text includes: sending the speech text to the book management system, and retrieving, by a virtual character interaction module in the book management system, the question in the preset knowledge base based on the speech text.

Optionally, if the question corresponding to the request information is not retrieved in the preset knowledge base, other resource information in the library in the preset knowledge base is retrieved by the virtual character interaction module based on the request information, to obtain the response text related to the request information.

Optionally, if the response text related to the request information is not retrieved in the other resource information in the library in the preset knowledge base, account data or book information of the book management system is accessed by the virtual character interaction module to obtain the response text related to the request information.

According to the embodiment of the present disclosure, the audio sequence may be generated and the virtual character may be rendered based on the response text related to the request information, to avoid a situation of no reply to the request, thereby improving the user experience.

Optionally, determining the speech symbol corresponding to the phoneme in the phoneme sequence includes:
determining a language of the phoneme in the phoneme sequence, determining a mapping rule corresponding to the phoneme according to the language, and determining the speech symbol corresponding to the phoneme in the phoneme sequence according to the mapping rule. Rules for mapping phonemes of different languages to speech symbols are different. The mapping rule corresponding to the phoneme may be determined according to the language of the phoneme in the phoneme sequence, and the speech symbol corresponding to the phoneme is determined according to the mapping rule.

S130, a lip movement driving parameter is determined according to the speech symbol and the style category, generating a video frame sequence according to the lip movement driving parameter and the virtual character, and outputting a virtual character interaction video composed of the video frame sequence and the audio sequence.

The lip movement driving parameter represents a driving parameter of a deformation controller of a set part of the face of the virtual character. For example, the deformation controller is used to control deformation of at least one area of a mouth area, a chin area, a cheek area, or the like of the virtual character. The face of the virtual character has multiple deformation controllers. For example, in a process of constructing the virtual character, deformation controllers are provided in an eye area, a mouth area, an eyebrow and forehead area, and a nose and cheek area of the virtual character. By inputting the driving parameter into the deformation controller of the corresponding area, the virtual character may be controlled to make corresponding expressions. For example, the lip movement driving parameter is input into the deformation controller corresponding to the mouth area to control the virtual character to make a lip movement corresponding to the audio, thereby ensuring synchronization between the voice and the lip movement.

Exemplarily, determining the lip movement driving parameter according to the speech symbol and the style category, generating the video frame sequence according to the lip movement driving parameter and the virtual character, and outputting the virtual character interaction video composed of the video frame sequence and the audio sequence includes: for each phoneme in the phoneme sequence, determining a corresponding speech symbol; determining a lip movement driving parameter corresponding to the phoneme according to the speech symbol corresponding to the phoneme in the phoneme sequence and the style category of the virtual character; determining video configuration information according to the speech synthesis markup language tag, sending the lip movement driving parameter, the video configuration information, and virtual character data to other server clusters other than a current server cluster, and generating, by the other server clusters, a video frame according to the lip movement driving parameter corresponding to the phoneme, the video configuration information, and the virtual character data, where the virtual character in the video frame presents a lip movement corresponding to the phoneme; generating the video frame sequence according to the lip movement driving parameter corresponding to each phoneme in the phoneme sequence, the video configuration information, and the virtual character data; and acquiring the video frame sequence of the virtual character output by the other server clusters.

The video configuration information is used to customize picture presentation of the virtual character. For example, the video configuration information includes at least one of an action of the virtual character, silent play duration of the virtual character, inserting a picture into a video frame, inserting a video into a video sequence, carousel of multiple pictures in a video sequence, a background switching effect, and a subtitle segmentation effect. The video configuration information may be configured in the response text through the SSML tag.

Rendering is a process of converting a three-dimensional model, a scene, or animation in a computer into a two-dimensional image or video. This process involves interaction between computer light rays and an object surface, including effects such as shadows, reflections, and refractions, to generate a realistic image. In the generation of the virtual character interaction video, a GPU in a server cluster other than the current server cluster renders video frames based on the lip movement driving parameter, the video configuration information, and the virtual character data, to obtain a series of video frames, and then obtain the video frame sequence.

The current server cluster parses the SSML tag to determine the video configuration information, and then sends the lip movement driving parameter and the video configuration information to the server cluster other than the current server cluster, and the video frame sequence is generated by the other server cluster according to the lip movement driving parameter, the video configuration information, and the virtual character data. In order to ensure security of the public resources of the library, the current server cluster may be a library server, so that data related to the resource information and the user information in the library is only processed in the internal network of the library. By sending the lip movement driving parameter and the video configuration information to other server clusters other than the current server cluster, rendering processing of the virtual character is performed by means of the other server clusters, which ensures security of the resource information and the user information in the library, reduces request concurrency of the current server cluster, avoids a situation of request queuing, and improves the user experience.

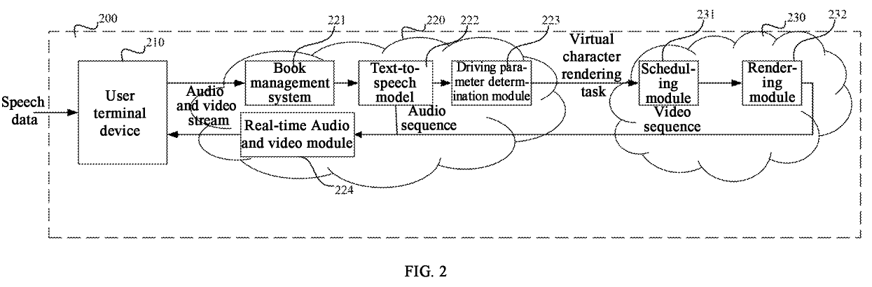

FIG. 2 is a public cloud deployment solution of a virtual character interaction system according to an embodiment of the present disclosure. As shown in FIG. 2, the virtual character interaction system 200 includes a user terminal device 210, a current server cluster 220, and other server clusters 230 other than the current server cluster 220. The current server cluster 220 and the other server clusters 230 are two server clusters isolated from each other. The current server cluster 220 includes a book management system 221, a text-to-speech model 222, a driving parameter determination module 223, and a real-time audio and video module 224. The user terminal device 210 logs in to the book management system 221 in the current server cluster 220 through a website of a library. The user terminal device 210 converts collected speech data into a speech text and determines configuration information according to user operation. The speech text and the configuration information are sent to the current server cluster 220. The book management system 221 retrieves a question in a preset knowledge base based on the speech text and determines a response text according to an answer matching the question. The response text is input into the text-to-speech model 222, and an audio sequence, a phoneme sequence, and an SSML tag are determined by the text-to-speech model 222 based on the response text. The phoneme sequence and the SSML tag are output by the text-to-speech model 222 to the driving parameter determination module 223. A speech symbol is determined by the driving parameter determination module 223 according to the phoneme sequence, and a determination strategy of a lip movement driving parameter is determined according to a style category of a virtual character in the configuration information. The lip movement driving parameter is determined based on the speech symbol by using the determination strategy corresponding to the style category. Optionally, the driving parameter determination module 223 parses the SSML tag to determine video configuration information. The driving parameter determination module 223 outputs a virtual character rendering task composed of the lip movement driving parameter, the video configuration information, and virtual character data to the other server clusters 230 other than the current server cluster 220. The other server clusters 230 include a scheduling module 231 and a rendering module 232. The scheduling module 231 is configured to schedule the virtual character rendering task. The rendering module 232 is configured to execute the virtual character rendering task, that is, render video frames according to the lip movement driving parameter, the video configuration information, and the virtual character data to obtain a video frame sequence. The current server cluster 220 acquires the video frame sequence output by the other server clusters 230. The audio sequence and the video frame sequence are input into the real-time audio and video module 224 to synthesize the audio sequence and the video frame sequence to obtain audio and video data, and the audio and video data is compressed to obtain an audio and video stream of a virtual character interaction video. The audio and video stream of the virtual character interaction video is sent by the real-time audio and video module 224 to the user terminal device 210.

Optionally, determining the lip movement driving parameter according to the speech symbol and the style category, generating the video frame sequence according to the lip movement driving parameter and the virtual character, and outputting the virtual character interaction video composed of the video frame sequence and the audio sequence includes: determining the lip movement driving parameter corresponding to a deformation controller of a face of the virtual character according to the speech symbol and the style category of the virtual character; and determining the video configuration information according to the speech synthesis markup language tag, and generating the video frame sequence according to the lip movement driving parameter, the video configuration information, and the virtual character data.

In order to ensure security of public resources of the library, the embodiment of the present disclosure may be implemented based on an internal network of the library. A user request speech and the configuration information are collected by an intelligent interaction device in the library, and the request speech is converted into the speech text. The intelligent interaction device sends the speech text and the configuration information to a server cluster, and the server cluster is composed of at least part of servers in the internal network of the library, so that the virtual character interaction video is generated in internal and external environments of the library, which avoids impact on information security caused by transmitting resource information and user information in the library to a public network.

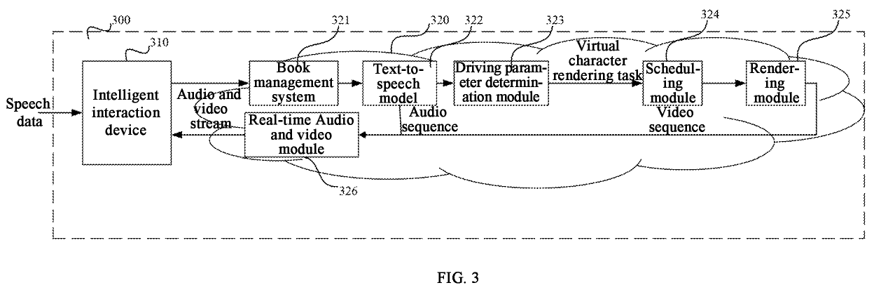

FIG. 3 is a private cloud deployment solution of a virtual character interaction system according to an embodiment of the present disclosure. As shown in FIG. 3, the virtual character interaction system 300 includes an intelligent interaction device 310 and a server cluster 320 in a library. The server cluster 320 includes a book management system 321, a text-to-speech model 322, a driving parameter determination module 323, a scheduling module 324, a rendering module 325, and a real-time audio and video module 326. The intelligent interaction device 310 collects speech data through a microphone, converts the collected speech data into a speech text, and determines configuration information according to user operation. The speech text and the configuration information are sent to the server cluster 320. The book management system 321 retrieves a question in a preset knowledge base based on the speech text and determines a response text according to an answer matching the question. The response text is input into the text-to-speech model 322, and an audio sequence, a phoneme sequence, and an SSML tag are determined by the text-to-speech model 322 based on the response text. The phoneme sequence and the SSML tag are output by the text-to-speech model 322 to the driving parameter determination module 323. A speech symbol is determined by the driving parameter determination module 323 according to the phoneme sequence, and a determination strategy of a lip movement driving parameter is determined according to a style category of a virtual character in the configuration information. The lip movement driving parameter is determined based on the speech symbol by using the determination strategy corresponding to the style category. Optionally, the driving parameter determination module 323 parses the SSML tag to determine video configuration information. The driving parameter determination module 323 outputs a virtual character rendering task composed of the lip movement driving parameter, the video configuration information, and virtual character data to the scheduling module 324. The scheduling module 324 is configured to schedule the virtual character rendering task. The rendering module 325 is configured to execute the virtual character rendering task, that is, render video frames according to the lip movement driving parameter, the video configuration information, and the virtual character data to obtain a video frame sequence. The audio sequence and the video frame sequence are input into the real-time audio and video module 326, the audio sequence and the video frame sequence are synthesized by the real-time audio and video module 326 to obtain a virtual character interaction video, and the virtual character interaction video is sent to the intelligent interaction device 310.

In the embodiment of the present disclosure, the virtual character interaction video is played on the user terminal device or the intelligent interaction device to realize real-time interaction between the user and the virtual character. The user may realize functions such as consulting book materials and inquiring personal information by means of a conversation with the virtual character, which avoids problems such as queuing blockage and service conflict that may exist when a librarian manually solves the user’s problems. According to the embodiment of the present disclosure, the user may access the book management system in the library or online, which meets a requirement of high-traffic users for efficient, intelligent, and secure book management.

According to the technical solution of the embodiment of the present disclosure, a speech text and configuration information are acquired, where the configuration information includes a style category of a virtual character; a response text is determined according to the speech text, an audio sequence and a phoneme sequence are determined according to the response text, and a speech symbol corresponding to a phoneme in the phoneme sequence is determined; and a lip movement driving parameter is determined according to the speech symbol and the style category, a video frame sequence is generated according to the lip movement driving parameter and the virtual character, and a virtual character interaction video composed of the video frame sequence and the audio sequence is output. Since the speech symbol is determined according to the phoneme sequence, and the lip movement driving parameter is determined according to the speech symbol and the style category, the virtual character is driven by the lip movement driving parameter to make a lip movement corresponding to the audio sequence, which improves the synchronization between the lip movement of the virtual character and the audio sequence, solves the problem caused by poor synchronization between the lip movement and the audio in related technologies, and improves the authenticity and vividness of the virtual character interaction.

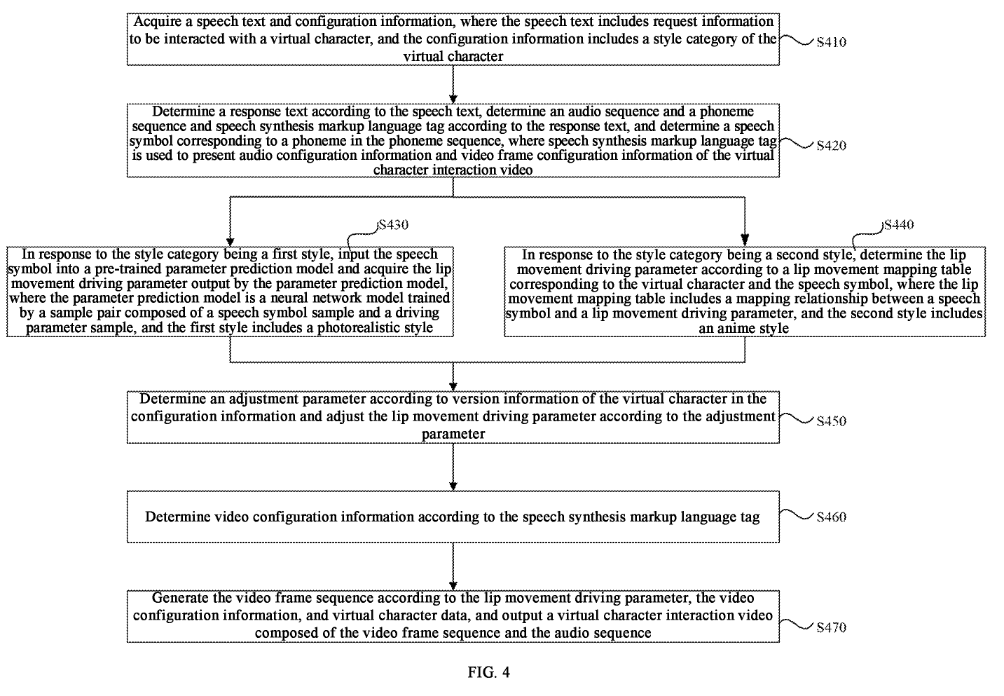

FIG. 4 is a schematic flowchart of another virtual character interaction method according to an embodiment of the present disclosure. On the basis of the above embodiments, the embodiment of the present disclosure specifically defines a determination manner of a lip movement driving parameter. As shown in FIG. 4, the method includes:

S410, a speech text and configuration information are acquired, where the speech text includes request information to be interacted with a virtual character, and the configuration information includes a style category of the virtual character.

S420, a response text is determined according to the speech text, an audio sequence, a phoneme sequence, and a speech synthesis markup language tag are determined according to the response text, and a speech symbol corresponding to a phoneme in the phoneme sequence is determined, where the speech synthesis markup language tag is used to represent audio configuration information and video frame configuration information of a virtual character interaction video.

The audio configuration information is used to configure a speech effect of the virtual character interaction video. The video frame configuration information is used to configure a picture display effect of the virtual character interaction video. For example, the speech effect includes at least one of: pronunciation, pause position and duration, local speaking speed, global speaking speed, local volume, global volume, local tone, global tone, text emotion, or the like. In the case of configuring the text emotion, a sentence may be divided into at least two emotion combination character strings by a comma, and emotion distribution is performed by specifying an emotion weight. The emotion distribution is used to set an influence degree of an emotion expressed by each of the at least two character strings on an emotion expressed by the sentence.

The picture display effect may include at least one of: an action library in an interaction state, an action library in a silent state, inserting a picture into a video frame, inserting another video into an interaction video, carousel of pictures in an interaction video, switching a background, subtitle segmentation, or the like. The action library in the interaction state includes a set of actions of the virtual character in the interaction state. Actions of different virtual characters in different interaction scenarios in the interaction state may be customized in advance. The action library in the silent state includes a set of actions of the virtual character in the silent state. Actions of different virtual characters in the silent state may be customized in advance.

In some embodiments, determining the audio sequence and the phoneme sequence according to the response text, and determining the speech symbol corresponding to the phoneme in the phoneme sequence includes: performing silence detection on the response text to obtain an silence segment, and deleting the silence segment in the response text; determining the audio sequence and the phoneme sequence according to the response text in which the silence segment is deleted; and determining a language of the phoneme in the phoneme sequence, determining a mapping rule corresponding to the phoneme according to the language, and determining the speech symbol corresponding to the phoneme in the phoneme sequence according to the mapping rule.

For example, a non-language character in the response text may be determined by a regular expression, and the silence segment is determined according to the non-language character. The silence segment in the response text is deleted. Preprocessing such as word segmentation is performed on the response text in which the silence segment is deleted, and a word segmentation result is input into a text-to-speech synthesis model. The text-to-speech synthesis model includes an embedding layer, an encoder, a decoder, a sound wave synthesis module, and the like. The word segmentation result is input into the embedding layer, and a text vector is determined by the embedding layer based on the word segmentation result. Then, high-dimensional feature extraction is performed on the text vector by the encoder to obtain a text feature. An audio spectrogram is generated frame by frame in an autoregressive manner by the decoder based on the text feature. An audio waveform is generated by the sound wave synthesis module based on the audio spectrogram to obtain the audio sequence.

Optionally, after word segmentation is performed on the response text from which the silence segment is deleted, characters corresponding to a word segmentation result may be converted into phonemes by a phoneme conversion module to obtain a phoneme sequence. Then, the phoneme sequence is input into the text-to-speech synthesis model to perform text-to-speech processing to obtain an audio sequence.

A language of a phoneme in the phoneme sequence is determined according to a language of a character in the response text. A mapping rule corresponding to the phoneme is determined according to the language, and a speech symbol corresponding to the phoneme in the phoneme sequence is determined according to the mapping rule. For example, for a Chinese character in the response text, a corresponding phoneme is Chinese pinyin, a language corresponding to the phoneme is Chinese, and a speech symbol of the phoneme corresponding to the Chinese pinyin is determined according to a mapping rule corresponding to Chinese. For an English word in the response text, a corresponding phoneme is an English letter, a language corresponding to the phoneme is English, and a speech symbol of the phoneme corresponding to the English letter is determined according to a mapping rule corresponding to English.

S430, in response to the style category being a first style, the speech symbol is input into a pre-trained parameter prediction model and the lip movement driving parameter output by the parameter prediction model is acquired, where the parameter prediction model is a neural network model trained by a sample pair composed of a speech symbol sample and a driving parameter sample, and the first style includes a photorealistic style.

In some embodiments, a phoneme sequence and a video frame sequence may be obtained based on a news video or other videos whose synchronization meets a requirement. A phoneme in the phoneme sequence is mapped to a speech symbol to obtain a speech symbol sample. A lip movement driving parameter sample is determined based on a face area of an anchor in a video frame. A sample pair is composed of the speech symbol sample and the lip movement driving parameter sample corresponding to the same video frame. A training sample set is composed of sample pairs. A neural network model is trained based on the training sample set to obtain the parameter prediction model.

Exemplarily, if the style category of the virtual character is the first style, the speech symbol is input into the parameter prediction model, and the corresponding lip movement driving parameter is predicted by the parameter prediction model and based on the speech symbol, and the lip movement driving parameter is output.

S440, in response to the style category being a second style, the lip movement driving parameter is determined according to a lip movement mapping table corresponding to the virtual character and the speech symbol, where the lip movement mapping table includes a mapping relationship between a speech symbol and a lip movement driving parameter, and the second style includes an anime style.

In some embodiments, a virtual character of the second style is created by a designer, and a driving parameter of a deformation controller of the virtual character corresponding to different speech symbols is adjusted, and the virtual character is rendered based on the driving parameter to screen virtual characters that meet a preset requirement. For different speech symbols, the lip movement driving parameter corresponding to the speech symbol is determined according to the driving parameter corresponding to the virtual character that meets the preset requirement. The lip movement mapping table corresponding to the virtual character is determined based on the lip movement driving parameter corresponding to the speech symbol. Parameters in lip movement mapping tables corresponding to different virtual characters are different. Since facial features of the anime style virtual character differ greatly from those of a real person or animal in proportion, and the anime style virtual characters are very different, it is difficult to obtain samples similar to the anime style virtual character in facial features proportion to train the neural network model. The prediction accuracy of the parameter prediction model for the lip movement driving parameter of the anime style virtual character is low. Therefore, the lip movement driving parameter matching the speech symbol may be quickly and accurately found through the pre-built lip movement mapping table.

Exemplarily, if the style category of the virtual character is the second style, the lip movement mapping table corresponding to the virtual character is searched according to the speech symbol to obtain the lip movement driving parameter corresponding to the speech symbol.

S450, an adjustment parameter is determined according to version information of the virtual character in the configuration information and the lip movement driving parameter is adjusted according to the adjustment parameter.

For example, for the virtual character of the first style, the adjustment parameter is determined according to the version information corresponding to the virtual character in the configuration information. A mapping relationship between the version information and the adjustment parameter is preset. The lip movement driving parameter may be adjusted based on the adjustment parameter. For example, the lip movement driving parameter may be adapted to the virtual character of the version through redirection technology.

For the virtual character of the second style, the adjustment parameter is determined according to the version information corresponding to the virtual character in the configuration information. The adjustment parameter and the lip movement driving parameter may be smoothly mixed and then subjected to down-sampling processing to obtain an adjusted lip movement driving parameter.

The lip movement driving parameter is adjusted based on the adjustment parameter corresponding to the version information, so that the virtual character driven by the lip movement driving parameter meets a style requirement of the virtual character of the version.

Optionally, after down-sampling, the method further includes: adjusting the lip movement driving parameter according to duration of a video sequence, so that a video frame rendered based on the lip movement driving parameter is aligned with the duration of the audio sequence. For example, for an audio of 5 seconds, assuming that 25 frames of video are played in 1 second, 125 frames of lip movement driving parameters are required. If there are 123 frames of video corresponding to the lip movement driving parameter, driving parameters corresponding to 2 frames of empty audio are inserted into the lip movement driving parameter to ensure that the number of video frames corresponding to the lip movement driving parameter is aligned with the duration of the audio sequence.

S460, video configuration information is determined according to the speech synthesis markup language tag.

S470, the video frame sequence is generated according to the lip movement driving parameter, the video configuration information, and virtual character data, and a virtual character interaction video composed of the video frame sequence and the audio sequence is output.

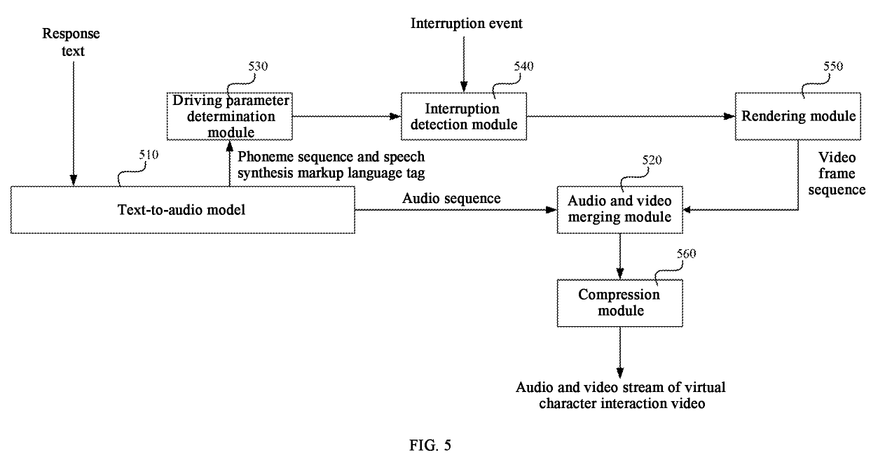

FIG. 5 is a flowchart of a method for generating a virtual character interaction video in a virtual character interaction method according to an embodiment of the present disclosure. As shown in FIG. 5, an audio sequence, a phoneme sequence, and a speech synthesis markup language tag are determined by a text-to-speech model 510 based on a response text, the audio sequence is output to an audio and video merging module 520, and the phoneme sequence and the speech synthesis markup language tag are output to a driving parameter determination module 530. The speech synthesis markup language tag is parsed by the driving parameter determination module 530 to obtain video configuration information and audio configuration information. The audio configuration information is used to adjust a speech effect of the audio sequence. A speech symbol sequence is determined by the driving parameter determination module 530 according to the phoneme sequence, and a lip movement driving parameter is determined according to the speech symbol sequence and a style category. An interruption event in an interaction process is detected by an interruption detection module 540. The interruption event represents that the user asks a new question when the virtual character is thinking or replying. If the interruption event is detected, an audio buffer queue and a video buffer queue that have not been played are cleared, and a state of the virtual character is switched to a silent state. If the interruption event is not detected, a rendering module 550 is called, so that the rendering module renders video frames based on the lip movement driving parameter, the video configuration information, and the virtual character data. A video frame sequence is obtained according to a series of video frames, and the video frame sequence is input into the audio and video merging module 520. The audio sequence and the video frame sequence are merged by the audio and video merging module 520 to obtain audio and video data, the audio and video data is output to a compression module 560, and an audio and video stream of the virtual character interaction video is output by the compression module 560.

According to the technical solution of the embodiment of the present disclosure, a speech text and configuration information are acquired, where the configuration information includes a style category of a virtual character; a response text is determined according to the speech text, an audio sequence and a phoneme sequence are determined according to the response text, and a speech symbol corresponding to a phoneme in the phoneme sequence is determined; for the virtual character of a photorealistic style, a lip movement driving parameter corresponding to the speech symbol is determined through a parameter prediction model; for the virtual character of a anime style, the lip movement driving parameter corresponding to the speech symbol is determined through a lip movement mapping table; and then, video frames are rendered according to the lip movement driving parameter, video configuration information, and virtual character data to obtain a video frame sequence. According to the embodiment of the present disclosure, the lip movement driving parameter may be determined in different manners according to the style category, which may improve accuracy of parameter determination and avoid a situation of asynchronization between audio and lip movement.

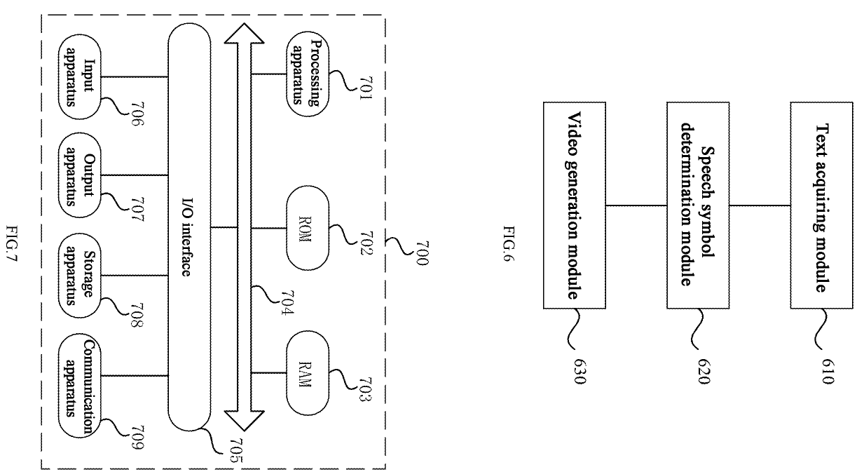

FIG. 6 is a schematic structural diagram of a virtual character interaction apparatus according to an embodiment of the present disclosure. The apparatus may be implemented in a form of software and/or hardware, and optionally, implemented by an electronic device, and the electronic device may be a mobile terminal, a PC, a server, or the like. As shown in FIG. 6, the apparatus includes: a text acquiring module 610, a speech symbol determination module 620, and a video generation module 630.

The text acquiring module 610 is configured to acquire a speech text and configuration information, where the speech text includes request information to be interacted with a virtual character, and the configuration information includes a style category of the virtual character;
the speech symbol determination module 620 is configured to determine a response text according to the speech text, determine an audio sequence and a phoneme sequence according to the response text, and determine a speech symbol corresponding to a phoneme in the phoneme sequence, where the speech symbol is used to describe lip movement information corresponding to the phoneme; and
the video generation module 630 is configured to determine a lip movement driving parameter according to the speech symbol and the style category, generate a video frame sequence according to the lip movement driving parameter and the virtual character, and output a virtual character interaction video composed of the video frame sequence and the audio sequence.

Optionally, the video generation module 630 includes a parameter determination sub-module;
the parameter determination sub-module is configured to, in response to the style category being a first style, input the speech symbol into a pre-trained parameter prediction model and acquire the lip movement driving parameter output by the parameter prediction model, where the parameter prediction model is a neural network model trained by a sample pair composed of a speech symbol sample and a driving parameter sample, and the first style includes a photorealistic style.

Optionally, the parameter determination sub-module is further configured to:
in response to the style category being a second style, determine the lip movement driving parameter according to a lip movement mapping table corresponding to the virtual character and the speech symbol, where the lip movement mapping table includes a mapping relationship between a speech symbol and a lip movement driving parameter, and the second style includes a anime style.

Optionally, the speech symbol determination module 620 includes a symbol determination sub-module;
the symbol determination sub-module is configured to perform silence detection on the response text to obtain an silence segment, and delete the silence segment from the response text; determine the audio sequence and the phoneme sequence according to the response text from which the silence segment is deleted; and determine a language of the phoneme in the phoneme sequence, determine a mapping rule corresponding to the phoneme according to the language, and determine the speech symbol corresponding to the phoneme in the phoneme sequence according to the mapping rule.

Optionally, the speech symbol determination module 620 includes an audio determination sub-module;
the audio determination sub-module is configured to retrieve a book management system according to the speech text to obtain the response text corresponding to the speech text, where the response text includes a speech synthesis markup language tag;
generate the audio sequence and the phoneme sequence according to the response text; and
determine audio configuration information according to the speech synthesis markup language tag and update an audio attribute of the audio sequence according to the audio configuration information.

Optionally, retrieving the book management system according to the speech text to obtain the response text corresponding to the speech text includes:
sending the speech text to the book management system, and retrieving a question in a preset knowledge base based on the speech text by the book management system; and
determining the response text according to an answer corresponding to the question matching the speech text, where the answer includes the speech synthesis markup language tag.

Optionally, the text acquiring module 610 is further configured to:
acquire the speech text and the configuration information sent by a user terminal device;
the video generation module 630 includes a video generation sub-module; and
the video generation sub-module is configured to determine video configuration information according to the speech synthesis markup language tag, send the lip movement driving parameter, the video configuration information, and virtual character data to other server clusters other than a current server cluster, and generate the video frame sequence according to the lip movement driving parameter, the video configuration information, and the virtual character data by the other server clusters; and
acquire the video frame sequence of the virtual character output by the other server clusters.

Optionally, the text acquiring module 610 is further configured to:
acquire the speech text and the configuration information sent by an intelligent interaction device in a library; and
the video generation sub-module is configured to determine the video configuration information according to the speech synthesis markup language tag and generate the video frame sequence according to the lip movement driving parameter, the video configuration information, and the virtual character data.

Optionally, the text acquiring module 610 is further configured to:
in response to a broadcast event, execute a preset script to determine broadcast content and the configuration information and determine the speech text according to the broadcast content.

The virtual character interaction apparatus provided by the embodiment of the present disclosure may perform the virtual character interaction method provided by any embodiment of the present disclosure, and has corresponding functional modules and beneficial effects for performing the method.

It is worth noting that the units and modules included in the apparatus are only divided according to functional logic, but are not limited to the above division, as long as the corresponding functions may be realized. In addition, the specific names of the functional units are only for the convenience of distinguishing from each other, and are not used to limit the protection scope of the embodiments of the present disclosure.

FIG. 7 is a schematic structural diagram of an electronic device according to an embodiment of the present disclosure. Reference is made to FIG. 7 below, which illustrates a schematic structural diagram of an electronic device (such as a terminal device or a server in FIG. 7) 700 suitable for implementing an embodiment of the present disclosure. The terminal device in the embodiment of the present disclosure may include, but is not limited to, a mobile terminal such as a mobile phone, a notebook computer, a digital broadcast receiver, a PDA (personal digital assistant), a tablet computer, a PMP (portable multimedia player), a vehicle-mounted terminal (such as a vehicle-mounted navigation terminal), etc., and a fixed terminal such as a digital TV, a desktop computer, etc. The electronic device shown in FIG. 7 is only an example, and should not bring any limitation to the function and use scope of the embodiments of the present disclosure.

As shown in FIG. 7, the electronic device 700 may include a processing apparatus (such as a central processing unit and a graphics processing unit) 701, which may perform various appropriate actions and processing according to a program stored in a read-only memory (ROM) 702 or a program loaded from a storage apparatus 708 into a random access memory (RAM) 703. In the RAM 703, various programs and data necessary for operations of the electronic device 700 are also stored. The processing apparatus 701, the ROM 702, and the RAM 703 are connected to each other through a bus 704. An input/output (I/O) interface 705 is also connected to the bus 704.

Usually, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a magnetic tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not necessary to implement or have all of the apparatuses shown. More or fewer apparatuses may be implemented or provided alternatively.

In particular, according to the embodiment of the present disclosure, the process described above with reference to the flowchart may be implemented as a computer software program. For example, the embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 709, or installed from the storage apparatus 708, or installed from the ROM 702. When the computer program is executed by the processing apparatus 701, the functions defined in the method of the embodiment of the present disclosure are executed.

The names of messages or information exchanged between multiple apparatuses in the implementations of the present disclosure are only for illustrative purposes, and are not intended to limit the scope of these messages or information.

The electronic device provided by the embodiment of the present disclosure belongs to the same inventive concept as the virtual character interaction method provided by the above embodiment, and for technical details not described in detail in this embodiment, reference may be made to the above embodiment, and this embodiment has the same beneficial effects as the above embodiment.

An embodiment of the present disclosure provides a computer storage medium, on which a computer program is stored, and the virtual character interaction method provided by the above embodiment is implemented when the program is executed by a processor.

It should be noted that the computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, a computer-readable storage medium may be any tangible medium that contains or stores a program, which may be used by or in combination with an instruction execution system, apparatus, or device. In the present disclosure, a computer-readable signal medium may include a data signal propagated on a baseband or as a part of a carrier, and computer-readable program code is carried therein. The data signal propagated in this way may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including, but not limited to, a wire, an optical cable, a radio frequency (RF), or any suitable combination thereof.

In some implementations, a client and a server may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be contained in the electronic device, or may exist alone without being assembled into the electronic device.

The computer-readable medium carries one or more programs, which, when executed by the electronic device, cause the electronic device to:
acquire a speech text and configuration information, where the speech text includes request information to be interacted with a virtual character, and the configuration information includes a style category of the virtual character;
determine a response text according to the speech text, determine an audio sequence and a phoneme sequence according to the response text, and determine a speech symbol corresponding to a phoneme in the phoneme sequence, where the speech symbol is used to describe lip movement information corresponding to the phoneme; and
determine a lip movement driving parameter according to the speech symbol and the style category, generate a video frame sequence according to the lip movement driving parameter and the virtual character, and output a virtual character interaction video composed of the video frame sequence and the audio sequence.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as "C" language or similar programming languages. The program code may be executed entirely on a user computer, partly on the user computer, as a stand-alone software package, partly on the user computer and partly on a remote computer, or entirely on the remote computer or a server. In the case of involving the remote computer, the remote computer may be connected to the user computer through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which includes one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented by software or by hardware. The name of a unit does not constitute a limitation on the unit itself under certain circumstances.

The functions described above may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The above description is only a preferred embodiment of the present disclosure and an explanation of the technical principles employed. Those skilled in the art should understand that the scope of disclosure involved in the present disclosure is not limited to the technical solutions formed by the specific combinations of the above technical features, and should also cover, without departing from the above disclosed concept, other technical solutions formed by any combination of the above technical features or their equivalent features. For example, the above features and the technical features disclosed in the present disclosure (but not limited to) with similar functions may be replaced with each other to form a technical solution.

In addition, although the operations are depicted in a particular order, this should not be understood as requiring the operations to be performed in the particular order shown or in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only exemplary forms for implementing the claims.

1. A virtual character interaction method, comprising:
acquiring a speech text and configuration information, wherein the speech text comprises request information to be interacted with a virtual character, and the configuration information comprises a style category of the virtual character;
determining a response text based on the speech text, determining an audio sequence and a phoneme sequence based on the response text, and determining a speech symbol corresponding to a phoneme in the phoneme sequence, wherein the speech symbol is configured to describe lip movement information corresponding to the phoneme; and
determining a lip movement driving parameter based on the speech symbol and the style category, generating a video frame sequence based on the lip movement driving parameter and the virtual character, and outputting a virtual character interaction video composed of the video frame sequence and the audio sequence.

2. The method of claim 1, wherein determining the lip movement driving parameter based on the speech symbol and the style category comprises:
inputting, in response to the style category being a first style, the speech symbol into a pre-trained parameter prediction model and acquiring a lip movement driving parameter output by the parameter prediction model, wherein the parameter prediction model is a neural network model trained by a sample pair composed of a speech symbol sample and a driving parameter sample, and the first style comprises a photorealistic style.

3. The method of claim 1, wherein determining the lip movement driving parameter based on the speech symbol and the style category comprises:
determining, in response to the style category being a second style, the lip movement driving parameter based on a lip movement mapping table corresponding to the virtual character and the speech symbol, wherein the lip movement mapping table comprises a mapping relationship between the speech symbol and the lip movement driving parameter, and the second style comprises an anime style.

4. The method of claim 2, wherein determining the audio sequence and the phoneme sequence based on the response text, and determining the speech symbol corresponding to the phoneme in the phoneme sequence comprise:
performing a silence detection on the response text to obtain a silence segment, and deleting the silence segment from the response text;
determining the audio sequence and the phoneme sequence based on the response text from which the silence segment is deleted; and
determining a language of the phoneme in the phoneme sequence, determining a mapping rule corresponding to the phoneme based on the language, and determining the speech symbol corresponding to the phoneme in the phoneme sequence based on the mapping rule.

5. The method of claim 1, wherein determining the response text based on the speech text, and determining the audio sequence and the phoneme sequence based on the response text comprises:
retrieving a book management system based on the speech text to obtain the response text corresponding to the speech text, wherein the response text comprises a speech synthesis markup language tag;
generating the audio sequence and the phoneme sequence based on the response text; and
determining audio configuration information based on the speech synthesis markup language tag and updating an audio attribute of the audio sequence based on the audio configuration information.

6. The method of claim 5, wherein retrieving the book management system based on the speech text to obtain the response text corresponding to the speech text comprises:
sending the speech text to the book management system, and retrieving, based on the speech text, a question in a preset knowledge base by the book management system; and
determining the response text based on an answer corresponding to a question matching the speech text, wherein the answer comprises the speech synthesis markup language tag.

7. The method of claim 5, wherein acquiring the speech text and the configuration information comprises:
acquiring the speech text and the configuration information sent by a user terminal device; and
wherein generating the video frame sequence based on the lip movement driving parameter and the virtual character comprises:
determining video configuration information based on the speech synthesis markup language tag, sending the lip movement driving parameter, the video configuration information, and virtual character data to other server clusters other than a current server cluster, and generating the video frame sequence based on the lip movement driving parameter, the video configuration information, and the virtual character data by the other server clusters; and
acquiring a video frame sequence of the virtual character output by the other server clusters.

8. The method of claim 5, wherein acquiring the speech text and the configuration information comprises:
acquiring a speech text and configuration information sent by an intelligent interaction device in a library; and
wherein generating the video frame sequence based on the lip movement driving parameter and the virtual character comprises:
determining video configuration information based on the speech synthesis markup language tag, and generating the video frame sequence based on the lip movement driving parameter, the video configuration information, and virtual character data.

9. The method of claim 5, wherein acquiring the speech text and the configuration information comprises:
executing, in response to a broadcast event, a preset script to determine broadcast content and the configuration information, and determining the speech text based on the broadcast content.

10. An electronic device, comprising:
one or more processors; and
a memory, configured to store one or more programs,
wherein the one or more programs, when executed by the one or more processors, cause the one or more processors to:
acquire a speech text and configuration information, wherein the speech text comprises request information to be interacted with a virtual character, and the configuration information comprises a style category of the virtual character;
determine a response text based on the speech text, determine an audio sequence and a phoneme sequence based on the response text, and determine a speech symbol corresponding to a phoneme in the phoneme sequence, wherein the speech symbol is used for describing lip movement information corresponding to the phoneme; and
determine a lip movement driving parameter based on the speech symbol and the style category, generate a video frame sequence based on the lip movement driving parameter and the virtual character, and output a virtual character interaction video composed of the video frame sequence and the audio sequence.

11. The electronic device according to claim 10, wherein the one or more programs causing the one or more processors to determine the lip movement driving parameter based on the speech symbol and the style category further cause the one or more processors to:
input, in response to the style category being a first style, the speech symbol into a pre-trained parameter prediction model and acquire a lip movement driving parameter output by the parameter prediction model, wherein the parameter prediction model is a neural network model trained by a sample pair composed of a speech symbol sample and a driving parameter sample, and the first style comprises a photorealistic style.

12. The electronic device according to claim 10, wherein the one or more programs causing the one or more processors to determine the lip movement driving parameter based on the speech symbol and the style category further cause the one or more processors to:
determine, in response to the style category being a second style, the lip movement driving parameter based on a lip movement mapping table corresponding to the virtual character and the speech symbol, wherein the lip movement mapping table comprises a mapping relationship between the speech symbol and the lip movement driving parameter, and the second style comprises an anime style.

13. The electronic device according to claim 11, wherein the one or more programs causing the one or more processors to determine the audio sequence and the phoneme sequence based on the response text, and determine the speech symbol corresponding to the phoneme in the phoneme sequence further cause the one or more processors to:
perform a silence detection on the response text to obtain a silence segment, and delete the silence segment from the response text;
determine the audio sequence and the phoneme sequence based on the response text from which the silence segment is deleted; and
determine a language of the phoneme in the phoneme sequence, determine a mapping rule corresponding to the phoneme based on the language, and determine the speech symbol corresponding to the phoneme in the phoneme sequence based on the mapping rule.

14. The electronic device according to claim 10, wherein the one or more programs causing the one or more processors to determine the response text based on the speech text, and determine the audio sequence and the phoneme sequence based on the response text further cause the one or more processors to:
retrieve a book management system based on the speech text to obtain the response text corresponding to the speech text, wherein the response text comprises a speech synthesis markup language tag;
generate the audio sequence and the phoneme sequence based on the response text; and
determine audio configuration information based on the speech synthesis markup language tag and update an audio attribute of the audio sequence based on the audio configuration information.

15. The electronic device according to claim 14, wherein the one or more programs causing the one or more processors to retrieve the book management system based on the speech text to obtain the response text corresponding to the speech text further cause the one or more processors to:
send the speech text to the book management system, and retrieve, based on the speech text, a question in a preset knowledge base by the book management system; and
determine the response text based on an answer corresponding to a question matching the speech text, wherein the answer comprises the speech synthesis markup language tag.

16. The electronic device according to claim 14, wherein the one or more programs causing the one or more processors to acquire the speech text and the configuration information further cause the one or more processors to:
acquire the speech text and the configuration information sent by a user terminal device; and
wherein the one or more programs causing the one or more processors to generate the video frame sequence based on the lip movement driving parameter and the virtual character further cause the one or more processors to:
determine video configuration information based on the speech synthesis markup language tag, send the lip movement driving parameter, the video configuration information, and virtual character data to other server clusters other than a current server cluster, and generate the video frame sequence based on the lip movement driving parameter, the video configuration information, and the virtual character data by the other server clusters; and
acquire a video frame sequence of the virtual character output by the other server clusters.

17. The electronic device according to claim 14, wherein the one or more programs causing the one or more processors to acquire the speech text and the configuration information further cause the one or more processors to:
acquire a speech text and configuration information sent by an intelligent interaction device in a library; and
wherein the one or more programs causing the one or more processors to generate the video frame sequence based on the lip movement driving parameter and the virtual character further cause the one or more processors to:
determine video configuration information based on the speech synthesis markup language tag, and generate the video frame sequence based on the lip movement driving parameter, the video configuration information, and virtual character data.

18. The electronic device according to claim 14, wherein the one or more programs causing the one or more processors to acquire the speech text and the configuration information further cause the one or more processors to:
execute, in response to a broadcast event, a preset script to determine broadcast content and the configuration information, and determine the speech text based on the broadcast content.

19. A non-transitory storage medium comprising computer-executable instructions, wherein the computer-executable instructions, when executed by a computer processor, cause the computer processor to:
acquire a speech text and configuration information, wherein the speech text comprises request information to be interacted with a virtual character, and the configuration information comprises a style category of the virtual character;
determine a response text based on the speech text, determine an audio sequence and a phoneme sequence based on the response text, and determine a speech symbol corresponding to a phoneme in the phoneme sequence, wherein the speech symbol is used for describing lip movement information corresponding to the phoneme; and
determine a lip movement driving parameter based on the speech symbol and the style category, generate a video frame sequence based on the lip movement driving parameter and the virtual character, and output a virtual character interaction video composed of the video frame sequence and the audio sequence.

20. The non-transitory storage medium according to claim 19, wherein the computer-executable instructions to determine the lip movement driving parameter based on the speech symbol and the style category comprise instructions to:
input, in response to the style category being a first style, the speech symbol into a pre-trained parameter prediction model and acquire a lip movement driving parameter output by the parameter prediction model, wherein the parameter prediction model is a neural network model trained by a sample pair composed of a speech symbol sample and a driving parameter sample, and the first style comprises a photorealistic style.
